(19) United States
(12) Patent Application Publication
(10) Pub. No.: US 2014/0240202 A1
(43) Pub. Date: Aug. 28, 2014

(54) INFORMATION PROCESSING METHOD AND APPARATUS FOR ELECTRONIC DEVICE

(71) Applicants: LENOVO (BEIJING) LIMITED, BEIJING (CN); BEIJING LENOVO SOFTWARE LTD., BEIJING (CN)

(72) Inventors: Qian Zhao, Beijing (CN); Yanyong Li, Beijing (CN)

(73) Assignees: LENOVO (BEIJING) LIMITED, BEIJING (CN); BEIJING LENOVO SOFTWARE LTD., BEIJING (CN)

(21) Appl. No.: 14/189,009

(22) Filed: Feb. 25, 2014

(30) Foreign Application Priority Data
Feb. 28, 2013 (CN) 201310064318.1

(51) Int. Cl. G06F 3/14

(52) U.S. Cl. CPC G06F 3/1446
USPC 345/1.3

(57) ABSTRACT

The present invention provides information processing method and apparatus. The method includes detecting, at a first electronic device, whether a first operation for adjusting a first parameter of a first component of the first electronic device is received; generating an adjustment instruction based on the first operation; and executing the adjustment instruction and transmitting the adjustment instruction to a second electronic device capable of exchanging data with the first electronic device for multi-device cooperation, so as to enable the second electronic device to adjust the first parameter of a second component of the second electronic device by executing the adjustment instruction. The second component and the first component are of the same type.

### TECHNICAL FIELD

The present invention relates to electronics, and more particularly, to information processing methods and apparatuses for electronic devices.

### BACKGROUND

With an development of science and technology, electronics technologies have been developing rapidly. There are more and more types of electronic products. Now, with various electronic devices, people can enjoy comfortable lives brought by technical development. For example, users can watch movies or view pictures using electronic devices such as mobile phones or tablet computers for playing video files.

Conventionally, in order to obtain a better visual effect, a user may combine several electronic devices together for use. In the case where several electronic devices are attached together, when the user needs to adjust a parameter value of a component in each of these electronic devices, he or she has to adjust the parameter of the component in each electronic device individually. In response to the adjustment by the user, the parameter of the component in each electronic device can be adjusted. For example, when a first tablet computer and a second tablet computer are attached together for displaying a single video jointly, if the user wants to adjust the brightness of the video, the user needs to adjust the first tablet computer and the second tablet computer individually. In response to the adjustment by the user, the brightness of each of the first and second tablet computers can be adjusted.

In contemplating the solutions according to the embodiments of the present application, the inventors found at least the following problems in the prior art. When a first tablet computer and a second tablet computer are attached together for multi-device cooperation, the first parameters of the first and second electronic devices are separately adjusted in response to a first adjustment instruction associated with a user operation for adjusting the first parameter of a first component of the first electronic device and a second adjustment instruction associated with a user operation for adjusting the first parameter of a second component of the second electronic device, respectively. That is, there is a problem that the same parameter of the first and second electronic devices cannot be adjusted based on a single adjustment instruction.

Due to the problem that the same parameter of the first and second electronic devices cannot be adjusted based on a single adjustment instruction, there is a further problem that the adjusted parameters may be different in the first and second electronic devices.

Since the corresponding parameters cannot be adjusted to be consistent in the first and second electronic devices when they are attached together, there is a yet further problem that the corresponding parameters may be different in the first and second electronic devices when they operate in a multi-device cooperative manner. For example, when two tablet computers are attached together, it is difficult to adjust brightness parameters of these two tablet computers to a same brightness value. In this case, when the two tablet computers are attached together for displaying a video jointly, a difference in brightness will deteriorate user experience.

### SUMMARY

The present invention provides information processing methods and apparatuses for an electronic device, capable of solving the problem in the prior art that the same parameter of the first and second electronic devices cannot be adjusted based on a single adjustment instruction.

According to an embodiment of the present invention, an information processing method is provided. The method comprises: detecting, at a first electronic device, whether a first operation for adjusting a first parameter of a first component of the first electronic device is received; generating an adjustment instruction based on the first operation; and executing the adjustment instruction and transmitting the adjustment instruction to a second electronic device capable of exchanging data with the first electronic device for multi-device cooperation, so as to enable the second electronic device to adjust the first parameter of a second component of the second electronic device by executing the adjustment instruction. The second component and the first component are of a same type.

According to another embodiment of the present invention, an information processing method is provided. The method comprises: receiving, at a second electronic device, an adjustment instruction that is generated at a first electronic device in response to receiving a first operation from a user for adjusting a first parameter of a first component of the first electronic device, the first electronic device being capable of exchanging data with the second electronic device for multi-device cooperation; and executing the adjustment instruction to adjust the first parameter of a second component of the second electronic device. The first electronic device is capable of executing the adjustment instruction to adjust the first parameter of the first component of the first electronic device. The second component and the first component are of a same type.

According to another embodiment of the present invention, an apparatus is provided. The apparatus is for use in a first electronic device capable of exchanging data with the second electronic device for multi-device cooperation. The apparatus comprises: a first detection unit configured to detect whether a first operation for adjusting a first parameter of a first component of the first electronic device is received; a generation unit configured to generate an adjustment instruction based on the first operation; and a first execution unit configured to execute the adjustment instruction and transmit the adjustment instruction to a second electronic device capable of exchanging data with the first electronic device for multi-device cooperation, so as to enable the second electronic device to adjust the first parameter of a second component of the second electronic device by executing the adjustment instruction. The second component and the first component are of a same type.

According to another embodiment of the present invention, an apparatus is provided. The apparatus is for use in a second electronic device capable of exchanging data with the first electronic device for multi-device cooperation. The apparatus comprises: a first reception unit configured to receive an adjustment instruction that is generated at a first electronic device in response to receiving a first operation from a user for adjusting a first parameter of a first component of the first electronic device; and a first execution unit configured to execute the adjustment instruction to adjust the first parameter of a second component of the second electronic device. The first electronic device is capable of executing the adjustment instruction to adjust the first parameter of the first component of the first electronic device.

### BRIEF DESCRIPTION OF THE DRAWINGS

FIG. 1 is a flowchart illustrating an information processing method according to an embodiment of the present invention;

FIG. 2 is a flowchart illustrating the information processing method prior to the step S101 according to an embodiment of the present invention;

FIG. 3 is a flowchart illustrating an information processing method according to another embodiment of the present invention;

FIG. 4 is a flowchart illustrating the information processing method prior to the step S301 according to an embodiment of the present invention;

FIG. 5 is a schematic diagram showing a structure of an apparatus according to an embodiment of the present invention; and

FIG. 6 is a schematic diagram showing a structure of an apparatus according to another embodiment of the present invention.

### DETAILED DESCRIPTION OF THE EMBODIMENTS

The embodiments of the present application provide information processing methods and apparatuses, capable of solving the problem in the prior art that the same parameter of the first and second electronic devices cannot be adjusted based on a single adjustment instruction.

In order to solve the above problem that the same parameter of the first and second electronic devices cannot be adjusted based on a single adjustment instruction, the general concept of the solutions according to the embodiments of the present application is as follows.

The first electronic device detects whether a first operation for adjusting a first parameter of a first component of the first electronic device is received. The first electronic device generates an adjustment instruction based on the first operation. The first electronic device executes the adjustment instruction and at the same time, transmits the adjustment instruction to the second electronic device, so as to enable the second electronic device to adjust the first parameter of a second component of the second electronic device by executing the adjustment instruction.

As noted above, since the first electronic device transmits the adjustment instruction to the second electronic device and then both the first and second electronic devices execute the adjustment instruction, it is possible to effectively solve the problem in the prior art that the same parameter of the first and second electronic devices cannot be adjusted based on a single adjustment instruction. It is then possible to solve the problem that the adjusted parameters may be different in the first and second electronic devices. The present invention can achieve the technical effect that the first and second electronic devices can adjust the same parameter of the first and second electronic devices simultaneously in response to the adjustment instruction generated based on the adjustment operation. The adjusted parameters are consistent with each other in the first and second electronic devices.

In the following, the above solutions will be described in detail with reference to the figures and embodiments, such that the above solutions can be better understood.

According to an embodiment of the present invention, an information processing method is provided. The method is applied in a first electronic device having a first display unit. In particular, the first electronic device may be a tablet computer or a mobile phone. Also, the second electronic device may be a tablet computer or a mobile phone. The present invention is not limited to any specific type of electronic device. The first electronic device is capable of exchanging data with the second electronic device for multi-device cooperation.

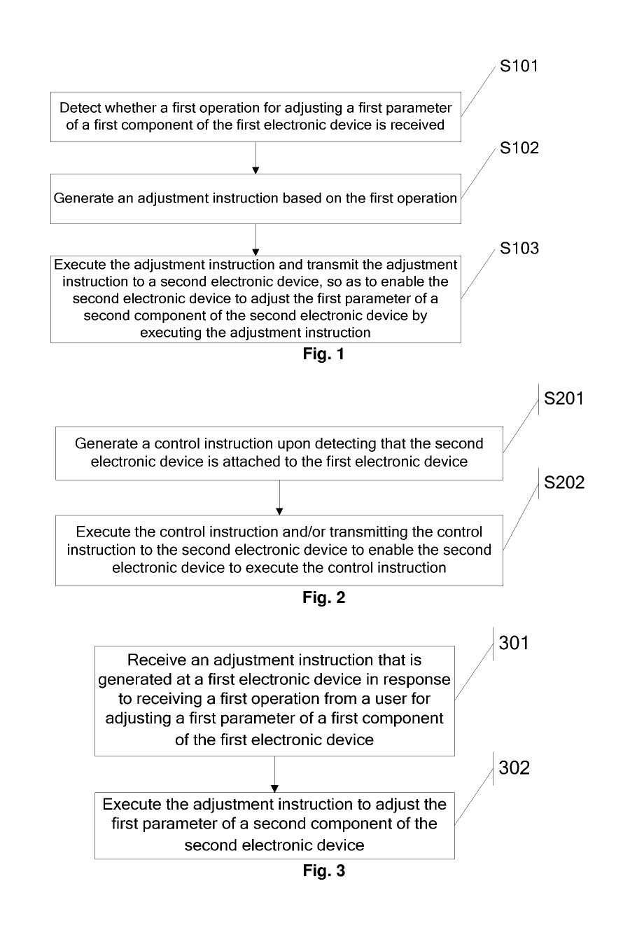

As shown in FIG. 1, the method includes the following steps.

At step S101, it is detected whether a first operation for adjusting a first parameter of a first component of the first electronic device is received.

At step S102, an adjustment instruction is generated based on the first operation.

At step S103, the adjustment instruction is executed and the adjustment instruction is transmitted to the second electronic device, so as to enable the second electronic device to adjust the first parameter of a second component of the second electronic device by executing the adjustment instruction. Here, the second component and the first component are of a same type.

The above solution will be explained in detail below with reference to FIGS. 1 and 2.

For example, the first and second electronic devices can be attached together to exchange data with each other for multi-device cooperation. For example, the first and second electronic devices can display a video file or an image or play an audio file jointly.

In the following example, it is assumed that the first and second electronic devices are attached together to play a video. Initially, the step S101 is executed, i.e., to detect whether a first operation for adjusting a first parameter of a first component of the first electronic device is received.

In particular, when a user performs the first operation on the first electronic device, the first operation by the user is detected by the first electronic device. In an embodiment, the first operation may be an operation to adjust a parameter, such as volume, display brightness or display size, of the first electronic device.

Specifically, when the first component is a first audio output unit of the first electronic device, and the second component is a second audio output unit of the second electronic device, the step of detecting whether the first operation is received includes: detecting whether a volume adjustment operation for adjusting a volume value of the first audio output unit is received.

When the first component is a first display unit of the first electronic device and the second component is a second display unit of the second electronic device, the step of detecting whether the first operation is received includes: detecting whether a display parameter adjustment operation for adjusting a display parameter of the first display unit is received. For example, the display parameter adjustment operation may include adjusting the brightness of the first display unit, scaling an image displayed on the display unit, or the like.

It is to be noted that the above examples of the first operation are merely intended to illustrate some operations that can be detected by the first electronic device. The operations that may be detected by the first electronic device are not limited to the above examples. Moreover, no matter what parameter the first operation is used to adjust, it may be an operation on a physical control element of the first electronic device, or a touch operation on the display unit of the first electronic device.

In an embodiment, the method further includes the following steps prior to the step S101.

At step S201, a control instruction is generated upon detecting that the second electronic device is attached to the first electronic device.

At step S202, the control instruction is executed and/or transmitted to the second electronic device to enable the second electronic device to execute the control instruction. Here, the first electronic device and/or the second electronic device execute the control instruction such that the first parameter of the first component of the first electronic device and the first parameter of the second component of the second electronic device have the same value.

Specifically, there are several methods for generating the control instruction upon detecting that the second electronic device is attached to the first electronic device, such that the first parameter of the first component of the first electronic device and the first parameter of the second component of the second electronic device have a same value. These methods will be explained below.

In the first method, only the first electronic device executes the control instruction. In this case, the first electronic device adjusts the first parameter of its first component to have the same value as that of the first parameter of the second component of the second electronic device. For example, when the first and second electronic devices have not been attached to each other, the volume value of the audio output unit of the first electronic device is 30% and the volume value of the audio output unit of the second electronic device is 80%. In this case the volume value of the audio output unit of the first electronic device is adjusted to 80% while the volume value of the audio output unit of the second electronic device remains unchanged. In this method, the adjustment instruction is not transmitted to the second electronic device. This brings reduction in delay.

In the second method, the first and second electronic devices execute the control instruction simultaneously. In this case, the same parameter of the same component may be adjusted to a more reasonable value, e.g., to a preconfigured parameter value, in the first and second electronic devices. For example, a volume value X and a brightness value Y may be preconfigured. In this case, when the second electronic device is attached to the first electronic device, the first and second electronic devices can adjust their respective volume values to X and their respective display brightness values to Y. Alternatively, the parameters can be adjusted to the average of the current values of the same parameter of the same component in the first electronic device and the second electronic device. For example, when the brightness value of the display unit of the first electronic device is 20% and the brightness value of the display unit of the second electronic device is 80%, the brightness value of the display unit of each of the first and second electronic devices may be adjusted to 50%.

In the third method, either the first electronic device or the second electronic device executes the control instruction. In this case, the values of the same parameter of the same component in the first electronic device and the second electronic device may be adjusted to the smaller one of these values. In this way, when the first and second electronic devices are attached, it is possible to avoid any adverse effect on one of the electronic devices caused by increasing a parameter of its component suddenly.

The present invention is not limited to any of the above three specific methods for causing the first parameter of the first component of the first electronic device and the first parameter of the second component of the second electronic device to have the same value.

After the first operation is detected in the step S101, the step S102 is performed to generate the adjustment instruction based on the first operation.

In an embodiment, different adjustment instructions may be generated depending on what kind of adjustment is made by the first operation.

In particular, when the first operation is a volume adjustment operation for adjusting a volume value of the first audio output unit of the first electronic device, a volume adjustment instruction is generated based on the volume adjustment operation.

Alternatively, when the first operation is a display parameter adjustment operation for adjusting a display parameter of the first display unit, a display parameter adjustment instruction is generated based on the display parameter adjustment operation.

Based on the adjustment instruction generated in the step S102, the step S103 is performed to execute the adjustment instruction and transmit the adjustment instruction to the second electronic device, so as to enable the second electronic device to adjust the first parameter of a second component of the second electronic device by executing the adjustment instruction. Here, the second component and the first component are of a same type.

In an embodiment, when the adjustment instruction generated in the step S102 is a volume adjustment instruction, the volume adjustment instruction is executed to adjust the volume value of the first audio output unit from a first volume value to a second volume value different from the first volume value. The volume adjustment instruction is transmitted to the second electronic device, so as to enable the second electronic device to adjust a volume value of the second audio output unit from the first volume value to the second volume value by executing the volume adjustment instruction.

In particular, the above may be implemented in two methods.

In the first method, the first and second electronic devices execute the adjustment instruction simultaneously. For example, when the current volume value of the first audio output unit of the first electronic device is 30% and the generated adjustment instruction is to “increase volume value by 40%”, the first electronic device executes the adjustment instruction and gradually increase the volume value of the first audio output unit from 30% to 70% in response to the user operation. Meanwhile, the instruction to “increase volume value by 40%” is transmitted to the second electronic device, so as to enable the second electronic device to execute the adjustment instruction at the same time to gradually increase the volume value of the second audio output unit from 30% to 70% in response to the user operation.

In the second method, the first electronic device gradually adjusts the volume value of the first audio output unit from a first volume value to a second volume value based on the volume adjustment instruction and transmits the adjusted second volume value to the second electronic device, so as to enable the second electronic device to switch the volume value of the second audio output unit from a first volume value to a second volume value based on the volume adjustment instruction.

In an embodiment, for example, when the adjustment instruction generated in the step S102 is a display parameter adjustment instruction, the display parameter adjustment instruction is executed to adjust the display parameter of the first display unit from a first display parameter value to a second display parameter value different from the first display parameter value and the display parameter adjustment instruction is transmitted to the second electronic device, so as to enable the second electronic device to adjust a display parameter value of the second display unit from the first display parameter value to the second display parameter value by executing the display parameter adjustment instruction.

For example, when the adjustment instruction is a brightness adjustment instruction, the first electronic device executes the brightness adjustment instruction to adjust the brightness of the first display unit from a first brightness value to a second brightness value different from the first brightness value. The brightness adjustment instruction is transmitted to the second electronic device, such that the second electronic device executes the brightness adjustment instruction to adjust the brightness of the second display unit from the first brightness value to the second brightness value different from the first brightness value. For example, when the user wants to increase the brightness values of the first and second electronic devices to 80%, a brightness adjustment instruction is generated in response to a brightness increase operation by the user on the first electronic device. The first electronic device executes the brightness adjustment instruction to adjust the brightness value of the first display unit to 80% and transmits the brightness adjustment instruction to the second electronic device, such that the second electronic device executes the brightness adjustment instruction to adjust the brightness value of the second display unit to 80%.

The solution according to this embodiment will be explained below in connection with an example in which the first electronic device is a first tablet computer, and the second electronic device is a second tablet computer.

For example, a user wants to watch movie using the first and second tablet computers. The user attaches the first and second tablet computer together such that they can exchange data for multi-device cooperation. Upon detection of that the second tablet computer is attached, the first tablet computer executes the first scheme of the step S202. In particular, the first tablet computer generates and executes a control instruction. Based on the obtained parameter values of the components of the second tablet computer, the parameter values of the components of the first tablet computer may be adjusted to be consistent with those of the corresponding components of the second tablet computer. For example, when the second tablet computer has a volume value of 50% and a brightness of 30%, the first tablet computer executes a control instruction to adjust its volume value to 50% and its brightness to 30%. In practice, the other methods of the step S202 as described above may also be adopted to control the parameters of the corresponding components to be consistent in the first and second tablet computers (the details thereof will be omitted here).

Then, the user uses the first and second tablet computers to play movie pictures. During the play, for example, the user considers that the brightness is too low for him or her to watch the movie clearly. Hence, the user operates to increase the brightness by sliding a brightness adjustment scrollbar on the display screen of the first tablet computer or pressing a physical key. Thus, the first tablet computer generates a corresponding brightness increasing instruction and transmits the generated brightness increasing instruction to the second tablet computer, such that the first and second tablet computers can execute the same brightness increasing instruction. In this way, while the user is sliding the brightness adjustment scrollbar or pressing the physical key, the brightness values of the first and second tablet computers can be increased synchronously. When the user stops his or her operation, the brightness values of the first and second tablet computers stop increasing. In this way, the adjusted brightness of the first and second tablet computers can be consistent with each other. For example, the user considers that the volume is too low and thus operates to increase the volume by sliding a volume adjustment scrollbar on the display screen of the second tablet computer or pressing a physical key. The second tablet computer generates a corresponding volume increasing instruction and transmits the generated volume increasing instruction to the first tablet computer, such that the first and second tablet computer can execute the volume increasing instruction simultaneously. Thus, while the user is sliding the scrollbar on the display screen or pressing the physical key, the volume values of the respective audio output units of the first and second tablet computers can be increased synchronously. When the user stops his or her operation, the volume values of the respective audio output units of the first and second tablet computers stop increasing.

As described above in connection with the example involving the first and second tablet computers, when the user attaches two electronic devices together for cooperation and performs an adjustment operation on any of these electronic devices, both electronic devices can respond to the adjustment operation. In this way, the user experience can be improved.

According to another embodiment of the present application, an information processing method is provided. The method is applied in a second electronic device having a second display unit. Each of the first and second electronic devices may be a tablet computer or a mobile phone. The present invention is not limited to any specific type of electronic device. The second electronic device is capable of exchanging data with the first electronic device for multi-device cooperation.

As shown in FIG. 3, the method includes the following steps.

At step S301, an adjustment instruction is received. The adjustment instruction is generated at the first electronic device in response to receiving a first operation from a user for adjusting a first parameter of a first component of the first electronic device.

At step S302, the adjustment instruction is executed to adjust the first parameter of a second component of the second electronic device. The first electronic device is capable of executing the adjustment instruction to adjust the first parameter of the first component of the first electronic device. The second component and the first component are of a same type.

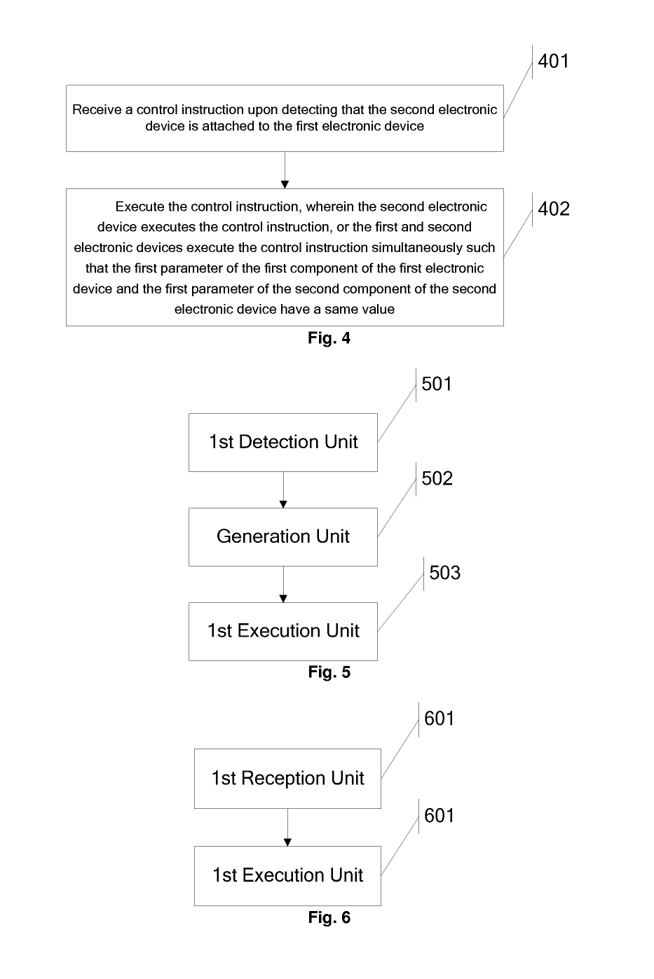

The above solution will be explained in detail below with reference to FIGS. 3 and 4.

In the case where the first and second electronic devices are attached together for multi-device cooperation, when the first electronic device generates an adjustment instruction in response to a first operation of the user for adjusting a first parameter of a first component of the first electronic device, the step S301 is performed to receive the adjustment instruction.

In an embodiment, the step of receiving an adjustment instruction may include receiving a volume adjustment instruction or a display parameter adjustment instruction, such as a brightness adjustment instruction or an image scaling adjustment instruction. The present application is not limited to any specific type of adjustment instruction.

In an embodiment, the method further includes the following steps prior to the step S301.

At step S401, a control instruction is received upon detecting that the second electronic device is attached to the first electronic device.

At step S402, the control instruction is executed. The second electronic device executes the control instruction, or the first and second electronic devices execute the control instruction simultaneously such that the first parameter of the first component of the first electronic device and the first parameter of the second component of the second electronic device have the same value.

Specifically, there are several methods for implementing the step S402.

In the first method, the second electronic device executes the control instruction to adjust the parameter value of its second component to have the same value as that of the first parameter of the first component of the first electronic device. For example, when the current brightness value of the display unit of the second electronic device is 40% and the current brightness value of the display unit of the first electronic device is 50%, the second electronic device executes a control instruction to adjust the brightness value of the display unit of the second electronic device to 50%.

In the second method, the first and second electronic devices execute the control instruction simultaneously. In this case, the same parameter of the same component may be adjusted to a more reasonable value, e.g., to a preconfigured parameter value, in the first and second electronic devices. For example, a volume value X and a brightness value Y can be preconfigured. In this case, when the second electronic device is attached to the first electronic device, the first and second electronic devices may adjust their respective volume values to X and their respective display brightness values to Y. Alternatively, the parameters may be adjusted to the average of the current values of the same parameter of the same component in the first electronic device and the second electronic device. For example, when the brightness value of the display unit of the first electronic device is 20% and the brightness value of the display unit of the second electronic device is 80%, the brightness value of the display unit of each of the first and second electronic devices can be adjusted to 50%.

In an embodiment, when the first component is a first audio output unit of the first electronic device, and the second component is a second audio output unit of the second electronic device, the step S302 includes executing the volume adjustment instruction to adjust a volume value of the second audio output unit from a first volume value to a second volume value different from the first volume value. The first electronic device is capable of adjusting a volume value of the first audio output unit from the first volume value to the second volume value by executing the volume adjustment instruction.

In an embodiment, when the first component is a first display unit of the first electronic device and the second component is a second display unit of the second electronic device, the step S302 includes executing the display parameter adjustment instruction to adjust a display parameter value of the second display unit from a first display parameter value to a second display parameter value different from the first display parameter value. The first electronic device is capable of adjusting a display parameter value of the first display unit from the first display parameter value to the second display parameter value by executing the display parameter adjustment instruction.

As an example, the first electronic device may be a first mobile phone, and the second electronic device may be a second mobile phone. Assuming that the user attaches the first and second mobile phones together to play an audio file, the audio file can be output using the audio output unit of the first mobile phone as a left channel and the audio output unit of the second mobile phone as a right channel. The user needs to adjust the volumes of the left and right channels simultaneously so as to ensure the consistency between the left and right channels.

The solution of this embodiment will be explained in detail in connection with the above example.

When the user wants to decrease the volume value of the audio file, he/she performs a volume decreasing operation on the first mobile phone. Thus, the first mobile phone detects the volume decreasing operation performed by the user and generates a volume decreasing instruction in response to the volume decreasing operation. Then, the second mobile phone may receive the volume decreasing instruction generated by the first mobile phone and execute it to decrease its volume value from a first volume value to a second volume value. The first mobile phone also executes the volume decreasing instruction to decrease its volume value from the first volume value to the second volume value. In this way, the volume values of the left and right channels may be adjusted in response to the single adjustment instruction, thereby ensuring the consistency in volume values between the left and right channels.

According to another embodiment of the present application, an apparatus is provided. The apparatus is for use in a first electronic device having a first display unit. The first electronic device is capable of exchanging data with the second electronic device for multi-device cooperation. Each of the first electronic device and the second electronic device may be a tablet computer or a mobile phone. The present invention is not limited to any specific type of electronic device.

As shown in FIG. 5, the apparatus includes the following structural units.

A first detection unit 501 is configured to detect whether a first operation for adjusting a first parameter of a first component of the first electronic device is received.

A generation unit 502 is configured to generate an adjustment instruction based on the first operation.

A first execution unit 503 is configured to execute the adjustment instruction and transmit the adjustment instruction to a second electronic device capable of exchanging data with the first electronic device for multi-device cooperation, so as to enable the second electronic device to adjust the first parameter of a second component of the second electronic device by executing the adjustment instruction. The second component and the first component are of a same type.

In an embodiment, the apparatus further includes: a second detection unit configured to generate a control instruction upon detecting that the second electronic device is attached to the first electronic device; and a second execution unit configured to execute the control instruction and/or transmit the control instruction to the second electronic device to enable the second electronic device to execute the control instruction. The first electronic device and/or the second electronic device execute the control instruction such that the first parameter of the first component of the first electronic device and the first parameter of the second component of the second electronic device have the same value.

In an embodiment, when the first component is a first audio output unit of the first electronic device and the second component is a second audio output unit of the second electronic device, the first detection unit comprises a volume adjustment detection sub-unit configured to detect whether a volume adjustment operation for adjusting a volume value of the first audio output unit is received.

In an embodiment, the generation unit comprises a volume adjustment instruction generation sub-unit configured to generate a volume adjustment instruction based on the volume adjustment operation.

In an embodiment, the first execution unit comprises a volume adjustment sub-unit configured to execute the volume adjustment instruction to adjust the volume value of the first audio output unit from a first volume value to a second volume value different from the first volume value; and a volume adjustment instruction transmission sub-unit configured to transmit the volume adjustment instruction to the second electronic device, so as to enable the second electronic device to adjust a volume value of the second audio output unit from the first volume value to the second volume value by executing the volume adjustment instruction.

In an embodiment, when the first component is a first display unit of the first electronic device and the second component is a second display unit of the second electronic device, the first detection unit comprises a display parameter adjustment detection sub-unit configured to detect whether a display parameter adjustment operation for adjusting a display parameter of the first display unit is received.

In an embodiment, the generation unit comprises a display parameter adjustment instruction generation sub-unit configured to generate a display parameter adjustment instruction based on the display parameter adjustment operation.

In an embodiment, the first execution unit comprises: a display parameter adjustment sub-unit configured to execute the display parameter adjustment instruction to adjust the display parameter of the first display unit from a first display parameter value to a second display parameter value different from the first display parameter value; and a display parameter adjustment instruction transmission unit configured to transmit the display parameter adjustment instruction to the second electronic device, so as to enable the second electronic device to adjust a display parameter value of the second display unit from the first display parameter value to the second display parameter value by executing the display parameter adjustment instruction.

According to another embodiment of the present application, an apparatus is provided. The apparatus is for use in a second electronic device having a second display unit. The second electronic device is capable of exchanging data with the first electronic device for multi-device cooperation. Each of the first electronic device and the second electronic device can be a tablet computer or a mobile phone. The present invention is not limited to any specific type of electronic device.

As shown, the apparatus includes the following structural units.

A first reception unit 601 is configured to receive an adjustment instruction that is generated at a first electronic device in response to receiving a first operation from a user for adjusting a first parameter of a first component of the first electronic device.

A first execution unit 602 is configured to execute the adjustment instruction to adjust the first parameter of a second component of the second electronic device. The first electronic device is capable of executing the adjustment instruction to adjust the first parameter of the first component of the first electronic device.

In an embodiment, the apparatus further includes: a second reception unit configured to receive a control instruction upon detecting that the second electronic device is attached to the first electronic device; and a second execution unit configured to execute the control instruction. The second electronic device executes the control instruction, or the first and second electronic devices execute the control instruction simultaneously, such that the first parameter of the first component of the first electronic device and the first parameter of the second component of the second electronic device have a same value.

In an embodiment, the first reception unit comprises a volume adjustment instruction reception sub-unit configured to receive a volume adjustment instruction; or a display parameter adjustment instruction reception sub-unit configured to receive a display parameter adjustment instruction.

In an embodiment, when the first component is a first audio output unit of the first electronic device and the second component is a second audio output unit of the second electronic device, the first execution unit comprises: a volume adjustment instruction execution sub-unit configured to execute the volume adjustment instruction to adjust a volume value of the second audio output unit from a first volume value to a second volume value different from the first volume value. The first electronic device is capable of adjusting a volume value of the first audio output unit from the first volume value to the second volume value by executing the volume adjustment instruction.

In an embodiment, the first component is a first display unit of the first electronic device and the second component is a second display unit of the second electronic device, the first execution unit comprises: a display parameter adjustment instruction execution sub-unit configured to execute the display parameter adjustment instruction to adjust a display parameter value of the second display unit from a first display parameter value to a second display parameter value different from the first display parameter value. The first electronic device is capable of adjusting a display parameter value of the first display unit from the first display parameter value to the second display parameter value by executing the display parameter adjustment instruction.

One or more of the solutions according to the embodiments of the present application have at least the following effects or advantages.

1. In the above solutions, when the first electronic device, upon detection of the first operation performed by the user, generates an adjustment instruction corresponding to the first operation, executes the adjustment instruction to adjust the first parameter of the first component of the first electronic device and transmits the adjustment instruction to the second electronic device cooperating with the first electronic device, such that the second electronic device can adjust the first parameter of the second component of the second electronic device by executing the adjustment instruction. In this way, it is possible to solve the problem in the prior art that the same parameter of the first and second electronic devices cannot be adjusted based on a single adjustment instruction. When the user performs an adjustment operation on the first electronic device, the generated adjustment instruction is transmitted to the second electronic device, such that the first and second electronic devices can respond to the adjustment instruction generated based on the adjustment operation simultaneously. Therefore, the technical effect of adjusting the same parameter in the first and second electronic devices simultaneously can be achieved.

2. In the above solutions, when the second electronic device receives and executes the adjustment instruction generated by the first electronic device, it adjusts the first parameter of the second component of the second electronic device in response to the adjustment instruction generated based on the first operation. Meanwhile, the first electronic device executes the adjustment instruction to adjust the first parameter of the first component of the first electronic device. In this way, it is possible to solve the problem in the prior art that the same parameter of the first and second electronic devices cannot be adjusted based on a single adjustment instruction. When the user performs an adjustment operation on the first electronic device, the second electronic device receives the generated adjustment instruction, such that the first and second electronic devices can respond to the adjustment instruction generated based on the adjustment operation simultaneously. Therefore, the technical effect of adjusting the same parameter in the first and second electronic devices simultaneously can be achieved.

3. The first and second electronic devices can adjust the same parameter in the first and second electronic devices simultaneously in response to the adjustment instruction generated based on the adjustment operation, it is thus possible to solve the problem that the adjusted parameters might be different in the first and second electronic devices. The present invention has the technical effect that the adjusted parameters are consistent with each other in the first and second electronic devices.

4. In the above solutions, upon detecting that the second electronic device is attached to the first electronic device, a control instruction is generated. The first electronic device and/or the second electronic device execute the control instruction, such that the first value of the first parameter of the first component of the first electronic device can be the same as the second value of the second parameter of the second component of the second electronic device. In this way, it is possible to solve the problem that the corresponding parameters may be different in the first and second electronic devices when they operate in a multi-device cooperative manner. The present invention has the technical effect that, when the second electronic device is attached to the first electronic device, the corresponding parameters in the first and second electronic devices can be automatically adjusted to a consistent value. For example, when the second electronic device is attached to the first electronic device, the volume values of the first and second electronic devices can be adjusted to a consistent value.

While the preferred embodiments of the present invention have been described, those skilled in the art can make further modifications and changes to these embodiment based on the fundamental inventive concept of the present invention. Therefore, the claims as attached are intended to cover the preferred embodiments and all the modifications and changes that fall within the scope of the present invention.

Various modifications and variants can be made to the present invention by those skilled in the art without departing from the spirit and scope of the present invention. Therefore, these modifications and variants are to be encompassed by the present invention if they fall within the scope of the present invention as defined by the claims and their equivalents.

What is claimed is:

1. An information processing method, comprising:
detecting, at a first electronic device, whether a first operation for adjusting a first parameter of a first component of the first electronic device is received;
generating an adjustment instruction based on the first operation; and
executing the adjustment instruction and transmitting the adjustment instruction to a second electronic device capable of exchanging data with the first electronic device for multi-device cooperation, so as to enable the second electronic device to adjust the first parameter of a second component of the second electronic device by executing the adjustment instruction,
wherein the second component and the first component are of a same type.

2. The method of claim 1, further comprising, prior to detecting whether the first operation is received:
generating a control instruction upon detecting that the second electronic device is attached to the first electronic device; and
executing, at the first electronic device, the control instruction, and/or transmitting the control instruction to the second electronic device to enable the second electronic device to execute the control instruction,
wherein the first electronic device and/or the second electronic device execute the control instruction such that the first parameter of the first component of the first electronic device and the first parameter of the second component of the second electronic device have a same value.

3. The method of claim 1, wherein the first component is a first audio output unit of the first electronic device, and the second component is a second audio output unit of the second electronic device,
said detecting whether the first operation is received comprises:
detecting whether a volume adjustment operation for adjusting a volume value of the first audio output unit is received.

4. The method of claim 3, wherein said generating the adjustment instruction based on the first operation comprises:
generating a volume adjustment instruction based on the volume adjustment operation.

5. The method of claim 4, wherein said executing the adjustment instruction and transmitting the adjustment instruction to the second electronic device so as to enable the second electronic device to adjust the first parameter of the second component of the second electronic device by executing the adjustment instruction comprises:
executing the volume adjustment instruction to adjust the volume value of the first audio output unit from a first volume value to a second volume value different from the first volume value; and
transmitting the volume adjustment instruction to the second electronic device, so as to enable the second electronic device to adjust a volume value of the second audio output unit from the first volume value to the second volume value by executing the volume adjustment instruction.

6. The method of claim 1, wherein the first component is a first display unit of the first electronic device, and the second component is a second display unit of the second electronic device,
said detecting whether the first operation is received comprises:
detecting whether a display parameter adjustment operation for adjusting a display parameter of the first display unit is received.

7. The method of claim 6, wherein said generating the adjustment instruction based on the first operation comprises:
generating a display parameter adjustment instruction based on the display parameter adjustment operation.

8. The method of claim 7, wherein said executing the adjustment instruction and transmitting the adjustment instruction to the second electronic device so as to enable the second electronic device to adjust the first parameter of the second component of the second electronic device by executing the adjustment instruction comprises:
executing the display parameter adjustment instruction to adjust the display parameter of the first display unit from a first display parameter value to a second display parameter value different from the first display parameter value; and
transmitting the display parameter adjustment instruction to the second electronic device, so as to enable the second electronic device to adjust a display parameter value of the second display unit from the first display parameter value to the second display parameter value by executing the display parameter adjustment instruction.

9. An information processing method, comprising:
receiving, at a second electronic device, an adjustment instruction that is generated at a first electronic device in response to receiving a first operation from a user for adjusting a first parameter of a first component of the first electronic device, the first electronic device being capable of exchanging data with the second electronic device for multi-device cooperation; and
executing the adjustment instruction to adjust the first parameter of a second component of the second electronic device,
wherein the first electronic device is capable of executing the adjustment instruction to adjust the first parameter of the first component of the first electronic device, and wherein the second component and the first component are of a same type.

10. The method of claim 9, further comprising, prior to receiving the adjustment instruction:
receiving a control instruction upon detecting that the second electronic device is attached to the first electronic device; and
executing the control instruction,
wherein the second electronic device executes the control instruction, or the first and second electronic devices execute the control instruction simultaneously such that the first parameter of the first component of the first electronic device and the first parameter of the second component of the second electronic device have a same value.

11. The method of claim 9, wherein said receiving the adjustment instruction comprises:
receiving a volume adjustment instruction; or
receiving a display parameter adjustment instruction.

12. The method of claim 11, wherein the first component is a first audio output unit of the first electronic device, and the second component is a second audio output unit of the second electronic device,
said executing the adjustment instruction to adjust the first parameter of the second component of the second electronic device comprises:
executing the volume adjustment instruction to adjust a volume value of the second audio output unit from a first volume value to a second volume value different from the first volume value, and
wherein the first electronic device is capable of adjusting a volume value of the first audio output unit from the first volume value to the second volume value by executing the volume adjustment instruction.

13. The method of claim 11, wherein the first component is a first display unit of the first electronic device, and the second component is a second display unit of the second electronic device,
said executing the adjustment instruction to adjust the first parameter of the second component of the second electronic device comprises:
executing the display parameter adjustment instruction to adjust a display parameter value of the second display unit from a first display parameter value to a second display parameter value different from the first display parameter value, and
wherein the first electronic device is capable of adjusting a display parameter value of the first display unit from the first display parameter value to the second display parameter value by executing the display parameter adjustment instruction.

14. An apparatus for use in a first electronic device, the first electronic device being capable of exchanging data with the second electronic device for multi-device cooperation, the apparatus comprising:
a first detection unit configured to detect whether a first operation for adjusting a first parameter of a first component of the first electronic device is received;
a generation unit configured to generate an adjustment instruction based on the first operation; and
a first execution unit configured to execute the adjustment instruction and transmit the adjustment instruction to a second electronic device capable of exchanging data with the first electronic device for multi-device cooperation, so as to enable the second electronic device to adjust the first parameter of a second component of the second electronic device by executing the adjustment instruction,
wherein the second component and the first component are of a same type.

15. The apparatus of claim 14, further comprising:
a second detection unit configured to generate a control instruction upon detecting that the second electronic device is attached to the first electronic device; and
a second execution unit configured to execute the control instruction and/or transmit the control instruction to the second electronic device to enable the second electronic device to execute the control instruction,
wherein the first electronic device and/or the second electronic device execute the control instruction such that the first parameter of the first component of the first electronic device and the first parameter of the second component of the second electronic device have a same value.

16. An apparatus for use in a second electronic device, the second electronic device being capable of exchanging data with the first electronic device for multi-device cooperation, the apparatus comprising:
a first reception unit configured to receive an adjustment instruction that is generated at a first electronic device in response to receiving a first operation from a user for adjusting a first parameter of a first component of the first electronic device; and
a first execution unit configured to execute the adjustment instruction to adjust the first parameter of a second component of the second electronic device,
wherein the first electronic device is capable of executing the adjustment instruction to adjust the first parameter of the first component of the first electronic device.

17. The apparatus of claim 16, further comprising:
a second reception unit configured to receive a control instruction upon detecting that the second electronic device is attached to the first electronic device; and
a second execution unit configured to execute the control instruction,
wherein the second electronic device executes the control instruction, or the first and second electronic devices execute the control instruction simultaneously, such that the first parameter of the first component of the first electronic device and the first parameter of the second component of the second electronic device have a same value.
